(19) United States
(12) Patent Application Publication
(10) Pub. No.: US 2018/0031415 A1
(43) Pub. Date: Feb. 1, 2018

(54) INTERFEROMETER SYSTEM HAVING A CONTINUOUSLY VARIABLE BROADBAND REFLECTOR AND METHOD TO GENERATE AN INTERFERENCE SIGNAL OF A SURFACE OF A SAMPLE

(71) Applicant: MITUTOYO CORPORATION, Kanagawa (JP)

(72) Inventors: Han HAITJEMA, Eindhoven (NL); Johannes Anna QUAEDACKERS, Veldhoven (NL); Adriaan Tiemen ZUIDERWEG, Breda (NL)

(73) Assignee: MITUTOYO CORPORATION, Kanagawa (JP)

(21) Appl. No.: 15/782,097

(22) Filed: Oct. 12, 2017

Related U.S. Application Data
(63) Continuation of application No. 14/291,710, filed on May 30, 2014.

(30) Foreign Application Priority Data
Jun. 10, 2013 (EP) 13171266.3

(51) Int. Cl. G01J 1/02; G02B 27/10; G01B 9/02; G02B 27/28

(52) U.S. Cl. CPC G01J 1/02; G02B 27/283; G02B 27/10; G01B 9/02012; G01B 9/02067; G01B 9/0209

(57) ABSTRACT

An interferometer system to generate an interference signal of a surface of a sample includes a broadband illuminator to provide a broadband illumination beam, a beam splitter to split the broadband illumination beam in a reference beam for reflection on a reference reflector and a measurement beam for reflection on the surface of the sample, and a detector to receive an interference radiation intensity created between the reference beam reflected from the reference reflector and the reflected measurement beam from the surface of the sample to generate an interference signal. The interferometer system having a continuous variable broadband reflector in the beam splitter and/or the reference reflector to adjust the broadband radiation intensity balance between the measurement beam and the reference beam.

### CROSS-REFERENCE TO RELATED APPLICATIONS

This is a continuation application of U.S. patent application Ser. No. 14/291,710, filed May 30, 2014, which claims priority under 35 U.S.C. §119 of European Application No. 13171266.3, filed on Jun. 10, 2013, the disclosure of which is expressly incorporated by reference herein in its entirety.

### BACKGROUND OF THE INVENTION

### 1. Field of the Invention

The invention relates to an interferometer system to generate an interference signal of a surface of a sample comprising:
a broadband illuminator to provide a broadband illumination beam;
a beam splitter to split the broadband illumination beam in a reference beam for reflection on a reference reflector and a measurement beam for reflection on the surface of the sample; and,
a detector to receive an interference radiation intensity created between the reference beam reflected from the reference reflector and the reflected measurement beam from the surface of the sample to generate an interference signal.

### 2. Description of Related Art

The interferometer system may be, for example, a Mirau, Michelson and/or Linnik interferometer apparatus. The system may be used to generate a correlogram displaying interference radiation intensity as a function of the scanning distance from the surface. Such apparatus may be used for determining a property (e.g. height, film thickness, refractive index) of a surface of a sample with a broadband (white light) illumination beam.

U.S. Pat. No. 6,538,809 discloses a variable illumination interference module for selective attachment to a microscope objective. The module having a reference mirror and a beam splitter, the beam splitter being positioned on an optical axis between said reference mirror and an object. A carrier means for supporting a plurality of beam splitters and for selectively positioning one of said plurality of beam splitters on said optical axis may be provided. Each of said plurality of beam splitters may have a different reflection/transmission ratio, whereby objects having different reflective values may be examined. The carrier means may be a turret supporting at least four beam splitters with respective reflection/transmission ratios of 20/80, 35/65, 43/57 and 50/50.

A problem may be that the carrier means supporting a plurality of beam splitters may be rather complex and require precise alignment of the beam splitters if the beam splitter are selectively positioned on the optical axis. The reflection/ transmission ratios of the plurality of beam splitters are fixed such that it is difficult to make small adjustments of the reflection transmission ratio.

### SUMMARY OF THE INVENTION

It is a feature to provide an improved interferometer system to generate an interference signal of a surface of a sample.

Accordingly, in an embodiment, there is provided an interferometer system to generate an interference signal of a surface of a sample including:

a broadband illuminator to provide a broadband illumination beam;

a beam splitter to split the broadband illumination beam in a reference beam for reflection on a reference reflector and a measurement beam for reflection on the surface of the sample; and

a detector to receive an interference radiation intensity created between the reference beam reflected from the reference reflector and the reflected measurement beam from the surface of the sample to generate an interference signal; wherein,

the interferometer system further comprises a continuous variable broadband reflector in at least one of the beam splitter and the reference mirror to adjust the broadband radiation intensity balance between the measurement beam and the reference beam.

The continuous variable broadband reflector is continuously variable such that the balance between the measurement beam and the reference beam may be precisely and continuously adjusted. The adjustment is not dependent of a particular beam splitter among a plurality of beam splitters in a turret.

The continuous variable broadband reflector may be provided in the beam splitter or on the reference reflector. The advantage of providing the continuous variable broadband reflector on the beam splitter is that no illumination radiation is lost compared to a situation where it is positioned on the reference reflector.

The continuous variable broadband reflector may be used to adjust the intensity balance between the measurement beam and the reference beam to such an extent that the interference radiation intensity received on the detector is optimized. For example, by the measurement beam and the reference beam having at the detector a substantially equal intensity.

In an embodiment the interferometer system includes a balance adjuster to adjust the reflectivity of the continuous variable broadband reflector to adjust the broadband radiation intensity balance between the measurement beam and the reference beam to optimize the interference radiation intensity. For example, a user interface may be provided with a knob to adjust the radiation intensity balance continuously or the apparatus may be provided with an automatic balancing device operably connected with the detector to inspect the interference intensity received on the detector and to adjust the radiation intensity balance continuously for optimal interference intensity on the detector.

In a further embodiment the continuous variable broadband reflector includes a first and second polarizer and one of the first and second polarizer has an adjustable continuous variable polarization to adjust the polarization of said one of the first and second polarizer with respect to the other of the first and second polarizer, thereby adjusting the reflectivity of the continuous variable broadband reflector. Said one of the first and second polarizer having an adjustable continuous variable polarization includes a liquid crystal with an electrically adjustable polarization.

In yet a further embodiment the continuous variable broadband reflector includes a metal reflector which is reflective in the metallic state while the hydride form of the metal reflector is transmissive for the broadband radiation and the continuous variable broadband reflector includes a source of at least one of hydrogen and protons to provide hydrogen and/or protons to the metal reflector so as to adjust the reflectivity of the metal reflector. The metal reflector may include a rare earth or transition metal, or a metal alloy.

In an embodiment the continuous variable broadband reflector includes a housing to create a gas controlled environment for the metal reflector and the interferometer system includes a hydrogen gas supply to control the hydrogen concentration in the housing to adjust the reflectivity of the metal reflector. The hydrogen gas supply may include a hydrolysis cell for the production of hydrogen for the gas controlled environment from water. In this way a compact gas supply may be provided.

In a further embodiment the continuous variable broadband reflector includes a proton donor layer and a connection for a power source to provide an electric potential difference between the metal reflector and the proton donor layer to transfer the protons from the proton donor layer to the metal reflector to provide protons to the metal reflector increasing the transmission of the metal reflector. In this way a rather simple variable broadband reflector can be made without any moving gases to adjust the reflectivity. The power source may be constructed and arranged to reverse the electric potential difference between the metal reflector and the proton donor layer thereby transferring the protons from the metal reflector to the proton donor layer thereby increasing the reflectivity of the metal reflector. The proton donor layer may include H_{X}WO₃.

In an embodiment the continuous variable broadband reflector may include a proton transmissible material between the proton donor layer and the metal reflector.

in an embodiment the continuous variable broadband reflector includes a capping layer for protection of the metal reflector. The metal reflector may need protection to oxygen or other gases in the atmosphere.

In an embodiment the interferometer system further includes:
a scanner constructed and arranged to scan the surface of the sample and the reference reflector optically with respect to each other over a scanning distance (through the focal plane) while measuring the scanning distance generating a scanning distance signal; and,
a processor to receive the interference signal representing the interference radiation intensity during the scan from the detector and the distance signal from the scanner and combining both to a correlogram displaying an interference radiation intensity as a function of the scanning distance. By scanning the surface through the focal plane of the interferometer system a correlogram can be produced which may be used to determine a surface property of the sample.

In an embodiment the continuous variable broadband reflector includes:
a temperature dependent reflector Which reflectivity is dependent on the temperature; and,
a temperature adjuster to adjust the temperature of the temperature dependent reflector to adjust the reflectivity of the temperature dependent reflector. In this way by simply adjusting the temperature the reflectivity may be adjusted.

According to an embodiment there is also provided a method to generate an interference signal of a surface of a sample with an interferometer system, the method including:
providing a broadband illumination beam;
splitting the illumination beam in a reference beam for reflection on a reference reflector and a measurement beam for reflection on the surface of the sample with a beam splitter;
receiving an interference radiation intensity created between the reference beam reflected from the reference reflector and the reflected measurement beam from the surface of the sample on a detector creating an interference signal; wherein,
the method includes adjusting the broadband radiation intensity balance between the measurement beam and the reference beam with a continuous variable broadband reflector in one of the beam splitter and the reference reflector.

In an embodiment the method further includes:
scanning the surface with respect to the measurement beam in a direction substantially perpendicular to the surface over a distance while creating a distance signal with a scanner; and,
receiving the interference signal representing the interference radiation intensity received on the detector from the detector and a distance signal from the scanner with a processor and combining both to a correlogram displaying an interference radiation intensity as a function of the distance from the surface to measure a surface property of the sample.

### BRIEF DESCRIPTION OF THE DRAWINGS

Embodiments of the invention will now be described, by way of example only, with reference to the accompanying schematic drawings in Which corresponding reference symbols indicate corresponding parts, and in which:

FIGS. 1a and 1b depict Mirau interferometer system according to an embodiment;

FIG. 2 discloses a Michelson interferometer system according to an embodiment;

FIG. 3 discloses a Linnik interferometer system according to an embodiment;

FIG. 4 discloses a continuous variable broadband reflector including a housing to create a gas controlled environment according to an embodiment;

FIG. 5 discloses a hydrolysis cell for the production of hydrogen according to an embodiment;

FIG. 6 discloses a continuous variable broadband reflector including a proton donor layer according to an embodiment; and,

FIG. 7 discloses a continuous variable broadband reflector including a temperature dependent reflector according to an embodiment.

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the forms of the present invention may be embodied in practice.

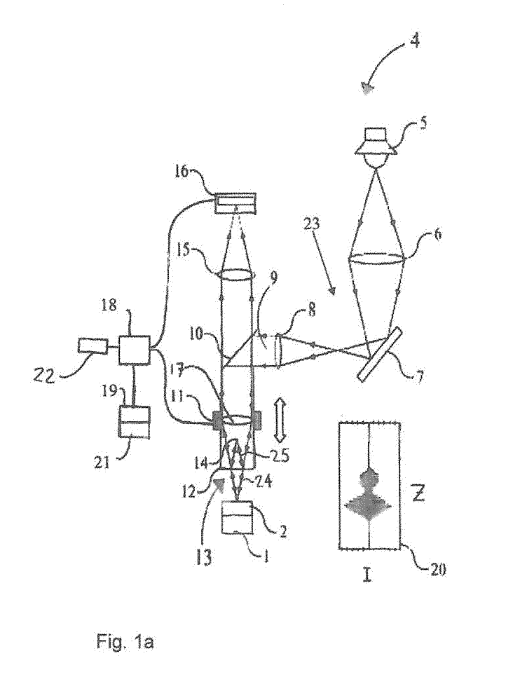

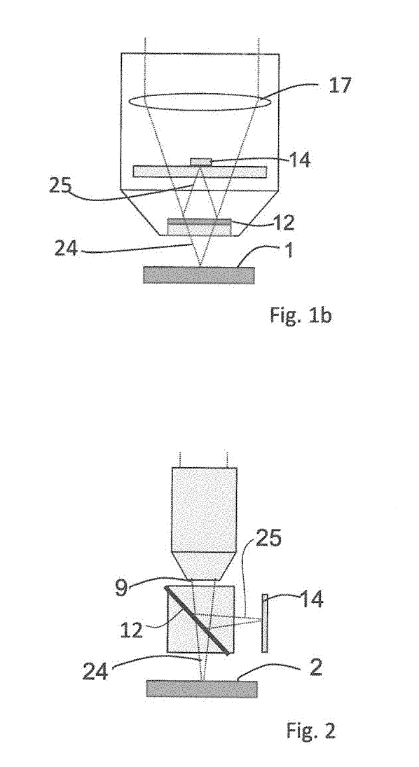

FIGS. 1a and 1b depict interferometer systems to measure a surface property of a sample 1 according to an embodiment. The measurement system includes an interferometer apparatus, for example a Mirau interferometer apparatus 4, a Michelson and/or Linnik interferometer apparatus may also be used.

The apparatus 4 may include a broadband illuminator 23 to provide a broadband illumination beam 9. The broadband illuminator may include a broadband radiation source 5, a first lens 6, a first mirror 7 and a second lens 8, to provide the broadband illumination beam 9. The broadband illumination beam may be parallel. The broadband illumination beam 9 may be reflected on a illumination beam splitter 10 and traverse through an objective lens 17 before it reaches a beam splitter 12 for splitting the broadband illumination beam in a reference beam 25 and a measurement beam 24.

The reference beam may be reflected on a reference reflector 14. The measurement beam may reflect from a surface of the sample 1 including thin film 2. The beam reflected from the reference reflector 14 may reflect again on the beam splitter 12. The beam reflected from the sample 1 and the thin film 2 may traverse through the beam splitter 12. The reference beam and the measurement beam may interfere and traverse through the objective lens 17, the illumination beam splitter 10 and a lens 15 to the detector 16. The intensity of the interference beam may be measured with the detector 16.

The reference reflector 14, the objective lens 17 and the beam splitter 12 may together form a Mirau objective and may be scanned optically with respect to the sample 1 along the optical axis and through the focal plane of the objective lens 17 with a scanner 11.

The interferometer system may include a continuous variable broadband reflector in the beam splitter 12 to adjust the broadband radiation intensity balance between the measurement beam 24 and the reference beam 25. The interferometer system may include a balance adjuster 22 operably connected to the beam splitter to adjust the reflectivity of the continuous variable broadband reflector to adjust the broadband radiation intensity balance between the measurement beam 24 and the reference beam 25 to optimize the interference radiation intensity on the detector 16. An advantage of having the continuous variable broadband reflector in the beam splitter 12 to adjust the broadband radiation intensity balance is that no illumination radiation is lost by adjusting the beam splitter. If less radiation is going to the reference beam, more light will be going to the measurement beam and vice versa. The total amount of radiation traversing through the beam splitter will be equal only the balance will be different. The intensity balance is optimized such that the measurement beam and the reference beam at the detector have a substantially equal intensity.

The interferometer system may include a continuous variable broadband reflector in the reference reflector 14 to adjust the broadband radiation intensity balance between the measurement beam 24 and the reference beam 25. The interferometer system may include a balance adjuster 22 operably connected to the reference reflector to adjust the reflectivity of the continuous variable broadband reflector to adjust the broadband radiation intensity balance between the measurement beam 24 and the reference beam 25 to optimize the interference radiation intensity. If less of the reference beam is being reflected by the reference reflector there will be no change in the light going to the measurement beam to compensate. Therefore the illumination radiation will be lost using the continuous variable broadband reflector in the reference reflector 14.

The signal of each of the pixels of the optical sensor 16 may be read out to obtain a correlogram as depicted in box 20 in FIG. 1, which depicts a received intensity 1 as a function of the Z-position Z of the sample 2. The apparatus may therefore be provided with a primary processor 18 for receiving for each pixel a signal representing the interference radiation intensity received on the detector 16 and a distance signal from the scanner 11 and combine both to a received correlogram 20 for each pixel displaying an interference radiation intensity as a function of the scanning distance from the sample. A property of the sample 2 may be determined from the cross correlogram made by cross correlator 19 with a secondary processor 21 of the correlogram 20.

The balance adjuster 22 may be connected to the detector and may be programmed to adjust the broadband radiation intensity balance between the measurement beam 24 and the reference beam 25 on the basis of the interference radiation intensity received on the detector 16.

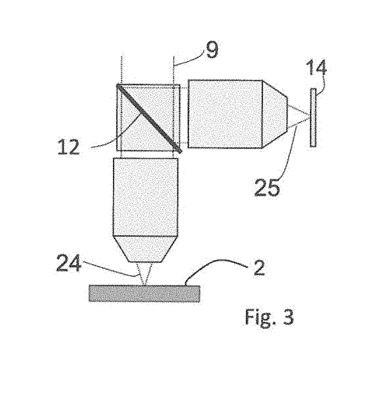

The interferometer apparatus may be for example a Mirau interferometer (FIG. 1), a Michelson interferometer (FIG. 2) or a Linnik interferometer apparatus (FIG. 3). In each of these interferometer systems the continuous variable broadband reflector in the beam splitter 12 and/or the reference reflector 14 may be used to adjust the broadband radiation intensity balance between the measurement beam 24 and the reference beam 25 thereby adjusting any imbalance in the intensity of the measurement beam 24 and the reference beam 25 caused by absorption on the sample 1.

The continuous variable broadband reflector may have a first and second polarizer and one of the first and second polarizer may have an adjustable continuous variable polarization to adjust the polarization of said one of the first and second polarizer with respect to the other of the first and second polarizer. The reflectivity of the continuous variable broadband reflector may thereby be adjusted to adjust the intensity balance between the measurement beam and the reference beam.

Several types of continuous variable broadband reflector using polarization can be used. For example, a Thorlabs (Inc) variable beam splitter may be used (see http://www.thorlabs.com./NewGroupPage9.cfm?objectgroup id=5503) or an ABSO High Energy Continuously Variable Beam Splitter may be used which is available from: http://marketplace.idexop.com/store/IdexCustom/PartDetails?pId=325. These continuous variable broadband reflectors are commercially available and can be used for beam splitters 12 or reference reflectors 14.

These function through polarization frustration. Radiation is passed through a first polarizer of one orientation. When a second polarizer (solid material or liquid crystal, optionally electrically or manually actuated for the angle of polarization) is used, the amount of radiation permitted to pass through is dependent on the angle of the polarization of the second polarizer relative to the first polarizer: when this angle is 0°, all radiation passes. At 90°, all is reflected.

A disadvantage may be that the radiation which is reflected from or passed through such a variable reflector is inherently polarized. This is not always ideal for interferometry. However, developments in the last two decades have given rise to continuous variable broadband reflector based on changing material phases, and overcome this limitation.

The continuous variable broadband reflector may include a metal reflector which is reflective in the metallic state while the hydride form of the metal reflector is transmissive for the broadband radiation. The metal reflector may include a rare earth or transition metal, or a metal alloy. The metal reflector may function on the basis of the varying properties of hydrides of some rare earth or transition metals, and their alloys (e.g. yttrium (YHₓ), lanthanum (LaH), magnesium lanthanum (MgLaHx), magnesium nickel (Mg₂NiHₓ) and others).

The layers may be sputtered as films on glass substrates and capped with capping layers of hydrogen transmissible metals such as palladium for protection against oxidation. These substances undergo a change from reflective metallic state to transparent semiconductor or insulator hydride states when a certain amount of hydrogen atoms are introduced. The continuous variable broadband reflector therefore may include a source of hydrogen and/or protons to provide hydrogen to the metal reflector so as to adjust the reflectivity of the metal reflector.

Though pure rare earth hydrides are colored, alloys of these or transition metals with magnesium are largely colorless. Transition metal-magnesium alloy hydrides can however pass to an intermediate black state in some circumstances because of the coexistence of the transparent and reflective states. The transition between the mirror state and the transparent state for hydride compounds is reversible in all circumstances, though durability may be an issue.

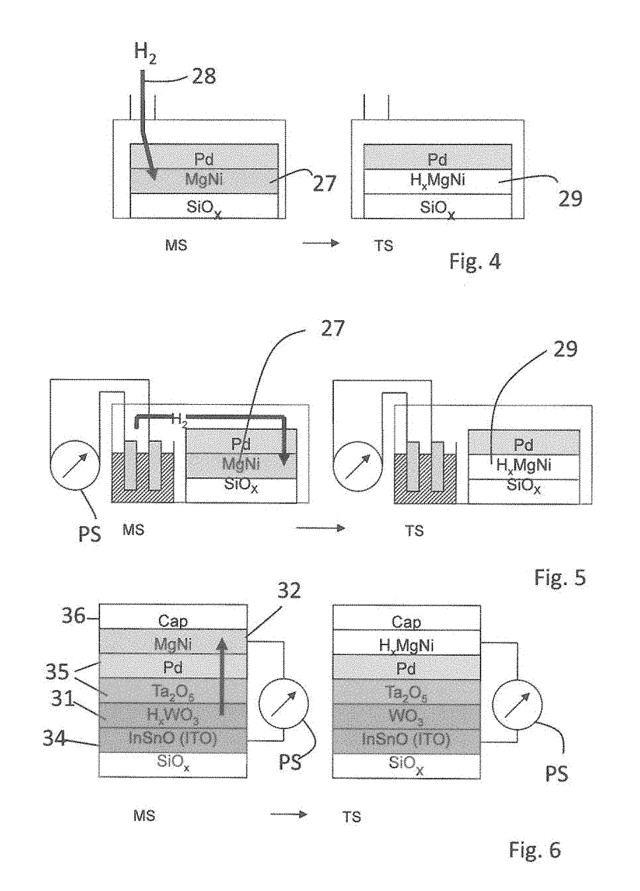

FIG. 4 discloses a continuous variable broadband reflector including a housing 26 to create a gas controlled environment for the metal reflector 27. The interferometer system includes a hydrogen gas supply 28 to control the hydrogen concentration in the housing 26 to adjust the reflectivity of the metal reflector 27. By providing hydrogen the metal reflector 27 is hydrogenated from a reflecting state MS into a radiation transmissive state 29, TS. The metal reflector may be used in the beam splitter 12 or the reference reflector 14. The introduction of hydrogen to such metal reflector material, inducing the transition, can be done by gas pressure from an external gas supply.

FIG. 5 discloses a hydrolysis cell 30 for the production of hydrogen for the gas controlled environment of FIG. 4. The introduction of hydrogen to the metal reflector material 27 in the reflecting state MS, induces the transition to the transmissive state TS. The later can be done by gas pressure from the introduction of in situ produced hydrogen (e.g. by electrolysis of water with two electrodes connected to a power source PS). Evacuation of the hydrogen from the material reverses the process and may be accomplished by a pump or passively venting of the housing 26.

In the proposed application, variable mirrors based on hydrides of rare earth or transition metals and alloys can also be switched through electrolytic proton transport means. In this latter technique the variable metal reflector material is included in a stack with a proton donor layer.

FIG. 6 discloses a continuous variable broadband reflector including a proton donor layer 31 and a connection for a power source PS to provide an electric potential difference between the metal reflector 32 and the proton donor layer 31 to transfer the protons from the proton donor layer 31 to the metal reflector 32 to provide hydrogen to the metal reflector increasing the transmission of the metal reflector 32. The power source PS may reverse the electric potential difference between the metal reflector 32 and the proton donor layer 31 thereby transferring the protons from the metal reflector to the proton donor layer thereby increasing the reflectivity of the metal reflector. The continuous variable broadband reflector includes on a glass substrate a transparent electrically conductive material 34 such as ITO (indium tin oxide (InSnO)), the proton donor layer 31 with hydrogenated tungsten oxide (H_{X}WO₃, wherein X may be 1 or 2), a proton transmissible material 35 such as tantalum (Ta) and/or palladium (Pd), and a metal reflector 32 of magnesium nickel (MgNi). In such a stack the application of an electric potential difference will ideally transfer protons to the variable metal reflector material 32, making it (more) transparent; while reversing the potential difference would draw these protons away, making it (more) reflective. Not applying any potential difference would leave the variable metal reflector in an equilibrium situation, thus in a steady state and remaining at the present reflectivity level.

The continuous variable broadband reflector may have a capping layer 36 for protection of the metal reflector 32. The metal reflector 32 may be sensitive to oxygen or other gases in the atmosphere and may be protected therefrom with the capping layer 36.

Similarly, the injection of ions of lithium, substituting for hydrogen, to rare earth and transition metals and alloys can be used to similar effect as the above, with purportedly the same results.

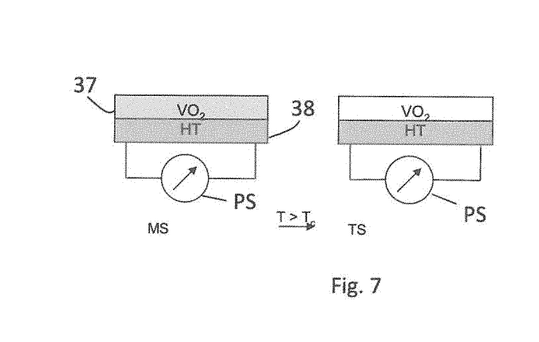

FIG. 7 discloses a continuous variable broadband reflector including a temperature dependent reflector 37 including vanadium dioxide (VO₂). The reflectivity is dependent on the temperature; and, a temperature adjuster 38 is provided to adjust the temperature of the temperature dependent reflector to adjust the reflectivity of the temperature dependent reflector. If the temperature of the reflector is larger than a critical temperature Tc the reflectivity is changed from a reflective state MS to a transmissive state TS. The temperature adjuster may be a resistor connected with a power source PS to heat the temperature dependent reflector or a Peltier element for heating and cooling.

It is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Furthermore, the terms and phrases used herein are not intended to be limiting, but rather, to provide an understandable description of the invention.

The terms “a” or “an”, as used herein, are defined as one or more than one. The term another, as used herein, is defined as at least a second or more. The terms including and/or having, as used herein, are defined as including (i.e., not excluding other elements or steps). Any reference signs in the claims should not be construed as limiting the scope of the claims or the invention. The mere fact that certain measures are recited in mutually different dependent claims does not indicate that a combination of these measures cannot be used to advantage. The scope of the invention is only limited by the following claims.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

What is claimed is:

1. An interferometer system to generate an interference signal of a surface of a sample comprising:
a broadband illuminator configured to provide a broadband illumination beam;
a beam splitter configured to split the broadband illumination beam into a reference beam for reflection on a reference reflector and into a measurement beam for reflection on the surface of the sample;
a detector configured to receive an interference radiation intensity created between the reference beam reflected from the reference reflector and the reflected measurement beam from the surface of the sample to generate an interference signal;
a continuous variable broadband reflector in at least one of the beam splitter and the reference reflector and configured to adjust the broadband radiation intensity balance between the measurement beam and the reference beam, the continuous variable broadband reflector comprising:
a temperature-dependent reflector which reflectivity is dependent on the temperature; and
a temperature adjuster configured to adjust the temperature of the temperature dependent reflector to adjust the reflectivity of the temperature dependent reflector;
a scanner configured to optically scan the surface of the sample and the reference reflector in the direction of the surface of the sample over a scanning distance while measuring the scanning distance and generating a scanning distance signal; and,
a processor configured to receive the interference signal representing the interference radiation intensity during the scan from the detector and the distance signal from the scanner and combining both to form a correlogram displaying an interference radiation intensity as a function of the scanning distance.

2. The interferometer system according to claim 1, wherein the temperature dependent reflector comprises vanadium dioxide.

3. The interferometer system according to claim 2, wherein, if the temperature dependent reflector is larger than a critical temperature, the reflectivity is changed from a reflective state to a transmissive state.

4. The interferometer system according to claim 1, wherein the temperature adjuster is a resistor connected to a power source to heat the temperature dependent reflector.

5. The interferometer system according to claim 2, wherein the temperature adjuster is a resistor connected to a power source to heat the temperature dependent reflector.

6. The interferometer system according to claim 3, wherein the temperature adjuster is a resistor connected to a power source to heat the temperature dependent reflector.

7. The interferometer system according to claim 1, wherein the temperature adjuster is a Peltier element for heating or cooling.

8. The interferometer system according to claim 2, wherein the temperature adjuster is a Peltier element for heating or cooling.

9. The interferometer system according to claim 3, wherein the temperature adjuster is a Peltier element for heating or cooling.

10. The interferometer system according to claim 4, wherein the temperature adjuster is a Peltier element for heating or cooling.

11. The interferometer system according to claim 5, wherein the temperature adjuster is a Peltier element for heating or cooling.

12. The interferometer system according to claim 6, wherein the temperature adjuster is a Peltier element for heating or cooling.

13. A method to generate an interference signal of a surface of a sample with an interferometer system, the method comprising:
emitting a broadband illumination beam;
splitting, by a beam splitter, the illumination beam into a reference beam for reflection on a reference reflector and into a measurement beam for reflection on the surface of the sample;
receiving an interference radiation intensity created between the reference beam reflected from the reference reflector and the reflected measurement beam from the surface of the sample on a detector creating an interference signal;
adjusting the broadband radiation intensity balance between the measurement beam and the reference beam with a continuous variable broadband reflector in at least one of the beam splitter and the reference reflector, the adjusting comprising adjusting a temperature of a temperature dependent reflector to adjust the reflectivity of the temperature dependent reflector;
optically scanning the surface of the sample and the reference reflector in the direction of the surface of the sample over a scanning distance while measuring the scanning distance and generating a scanning distance signal; and
receiving the interference signal representing the interference radiation intensity during the scan from the detector and the scanning distance signal, and combining both to form a correlogram displaying an interference radiation intensity as a function of the scanning distance.

14. The interferometer system according to claim 13, wherein the temperature dependent reflector comprises vanadium dioxide.

15. The interferometer system according to claim 14, wherein, if the temperature dependent reflector is larger than a critical temperature, the reflectivity is changed from a reflective state to a transmissive state.

16. The interferometer system according to claim 13, wherein the temperature adjuster is a resistor connected to a power source to heat the temperature dependent reflector.

17. The interferometer system according to claim 14, wherein the temperature adjuster is a resistor connected to a power source to heat the temperature dependent reflector.

18. The interferometer system according to claim 15, wherein the temperature adjuster is a resistor connected to a power source to heat the temperature dependent reflector.

19. The interferometer system according to claim 13, wherein the temperature adjuster is a Peltier element for heating or cooling.

20. The interferometer system according to claim 14, wherein the temperature adjuster is a Peltier element for heating or cooling.

21. The interferometer system according to claim 15, wherein the temperature adjuster is a Peltier element for heating or cooling.

22. The interferometer system according to claim 16, wherein the temperature adjuster is a Peltier element for heating or cooling.

23. The interferometer system according to claim 17, wherein the temperature adjuster is a Peltier element for heating or cooling.

24. The interferometer system according to claim 18, wherein the temperature adjuster is a Peltier element for heating or cooling.
